(19) United States
(12) Patent Application Publication
(10) Pub. No.: US 2008/0111826 A1
(43) Pub. Date: May 15, 2008

(54) Displaying resources using multiple visualization dimensions

(75) Inventors: Serguei N. Endrikhovski, Bellevue, WA (US); Paul Michel ElRif, Kirkland, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/599,014

(22) Filed: Nov. 14, 2006

(51) Int. Cl. G09G 5/00; G09G 5/02

(52) U.S. Cl. 345/582; 345/581; 345/589

(57) ABSTRACT

Aspects of the subject matter described herein relate to arranging resource representations in multiple visual dimensions according to two or more attributes associated with the resources. In aspects, a user interface receives input that associates attributes with visualization dimensions. The user interface may also receive filter input that indicates criteria to use to filter the resources. After receiving the input, the user interface may then display the representations according to the attributes, visualization dimensions, and filter, if any. For the visualization dimensions displayed, resources with different attributes are displayed such that they can be distinguished from each other in a manner that is consistent with their attributes. This may be done spatially, by color, by size or shape, or in some other visually distinguishing manner.

### BACKGROUND

A file explorer may arrange icons representing resources on a display based on an attribute of the resources. For example, files may be displayed alphabetically based on the names of the resources. As another example, files may be ordered based on the file size or date modified.

Sometimes, a file explorer will provide a tool bar that allows the user to change the attribute used to arrange the icons. By selecting the tool bar, a user may change from sorting the icons by file name to sorting the icons by file size, for example.

### SUMMARY

Briefly, aspects of the subject matter described herein relate to arranging resource representations in multiple visual dimensions according to two or more attributes associated with the resources. In aspects, a user interface receives input that associates attributes with visualization dimensions. The user interface may also receive filter input that indicates criteria to use to filter the resources. After receiving the input, the user interface may then display the representations according to the attributes, visualization dimensions, and filter, if any. For the visualization dimensions displayed, resources with different attributes are displayed such that they can be distinguished from each other in a manner that is consistent with their attributes. This may be done spatially, by color, by size or shape, texture, or in some other visually distinguishing manner.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” should be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a diagram that represents an exemplary window that displays resources in two visualization dimensions in accordance with aspects of the subject matter described herein;

FIG. 3 is a diagram that represents an exemplary window that displays resources in three visualization dimensions in accordance with aspects of the subject matter described herein;

FIG. 4 is a diagram that represents an exemplary dialog box that may be used to associate a visualization dimension with an attribute according to aspects of the subject matter described herein;

FIG. 5 is a diagram that represents an exemplary window including a view finder that displays resources in two visualization dimensions in accordance with aspects of the subject matter described herein; and

FIG. 6 is a flow diagram that generally represents exemplary actions that may occur in displaying representations of resources according to multiple visualization dimensions according to aspects of the subject matter described herein.

### DETAILED DESCRIPTION

### Exemplary Operating Environment

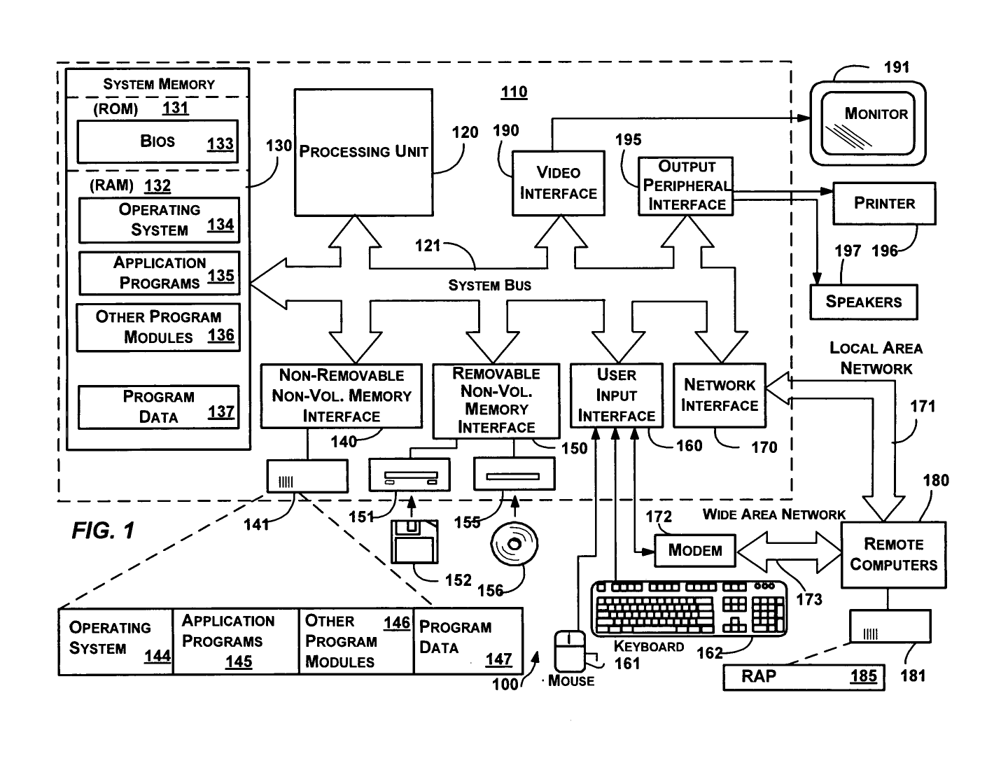

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 110. Computer storage media may be local or non-local. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170 which may use a wired or wireless protocol. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Resource Explorer

In an embodiment, a resource may include data, an entity, a program, a process, a product, a network, a representation of any of the above, or the like. In another embodiment, a resource may correspond to a file or folder in a file system. The file system may be physical or virtual and/or local or remote. Aspects of the subject matter described herein may be applied to both direct access storage (DAS) and a storage area network (SAN).

A resource may include or be associated with one or more attributes. An attribute may include, for example, type, size, creation date, modification date, last access date, name, location, read/write attributes, security attributes, author, owner, user rating, frequency of access, memory usage, connection status, policies, network throughput, and the like. Some attributes may be binary (e.g., read-only, write-only, hidden). Other attributes may correspond to integer or real number values. Yet other attributes may correspond to strings, dates, or time.

A containing resource (e.g., a folder) may have attributes that apply to or are in common with all the resources contained therein. For example, a containing resource may have an attribute that indicates the combined size of all files and folders included in the resource. As another example, a containing resource may have a last modified date, last accessed date, read/write attributes, frequency of access, and so forth that correspond to attributes of the resources contained therein. Thus, the last modified date of a containing resource may correspond to the date at which any of the resources within the resource was modified. Although examples are described below that reference resources corresponding to files and folders, it will be understood that the aspects described herein may also be applied to other types of resources without departing from the spirit or scope of aspects of the subject matter described herein.

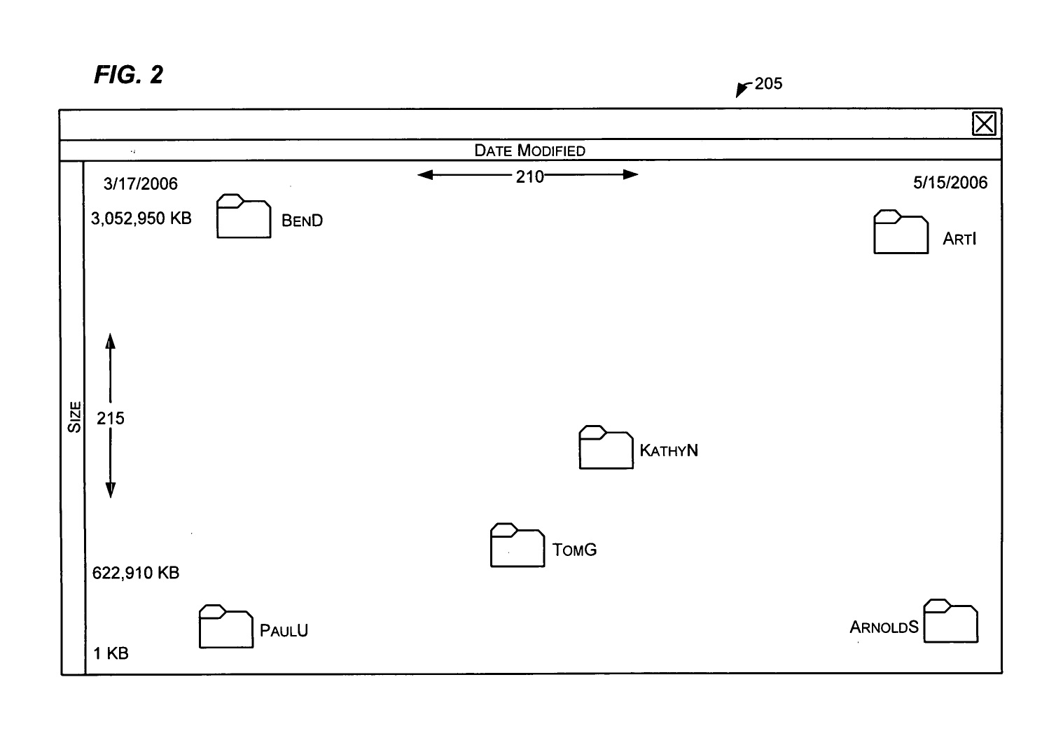

Sometimes it may be desired to organize resources based on more than one attribute. For example, in order to archive large and non-recently accessed files, a system administrator or the like may want to group folders based on their size and last access date. FIG. 2 is a diagram that represents an exemplary window that displays resources in two visualization dimensions in accordance with aspects of the subject matter described herein. The resources are arranged in the window 205 such that the date modified and size attributes correspond to horizontal 210 and vertical 215 dimensions, respectively. The date modified ranges from the oldest date (Mar. 17, 2006) on the left to the latest date (May 15, 2006) on the right. The size ranges from the smallest value (1 KB) at the bottom to the largest value (3,052,590 KB) on the top. By arranging the resources in this manner, it can be easily seen that the largest and oldest folder (BenD) is in the top left corner of the window 205.

In another example, along one visualization dimension, names of files may be shown (e.g., grouped by the first letter of the name) while along another visualization dimension, the sizes of the files may be shown. It will be recognized that attributes may be associated with visualization dimensions in many permutations without departing from the spirit or scope of aspects of the subject matter described herein.

A distribution of icons may yield a tight clustering. In one embodiment, a user may drag a rectangle around the tight clustering to change the scale used to distribute the icons. In another embodiment, a log scale or other transformation may be used along a visualization dimension. In another embodiment, icons may be displayed along visualization dimensions without blank spaces between them, so that their arrangement is more compact.

Icons representing resources that have the same or similar attributes may overlap each other when displayed according to visual dimensions. In one embodiment, a user may drag a rectangle around the overlapping icons or right click on a clustering of icons to cause them to be separated from each other. In one embodiment, the icons may be separated by a process that randomly distributes the icons around the point where they overlap. In another embodiment, other attributes of the resources represented by the icons may be used to distribute the icons such that the icons no longer overlap.

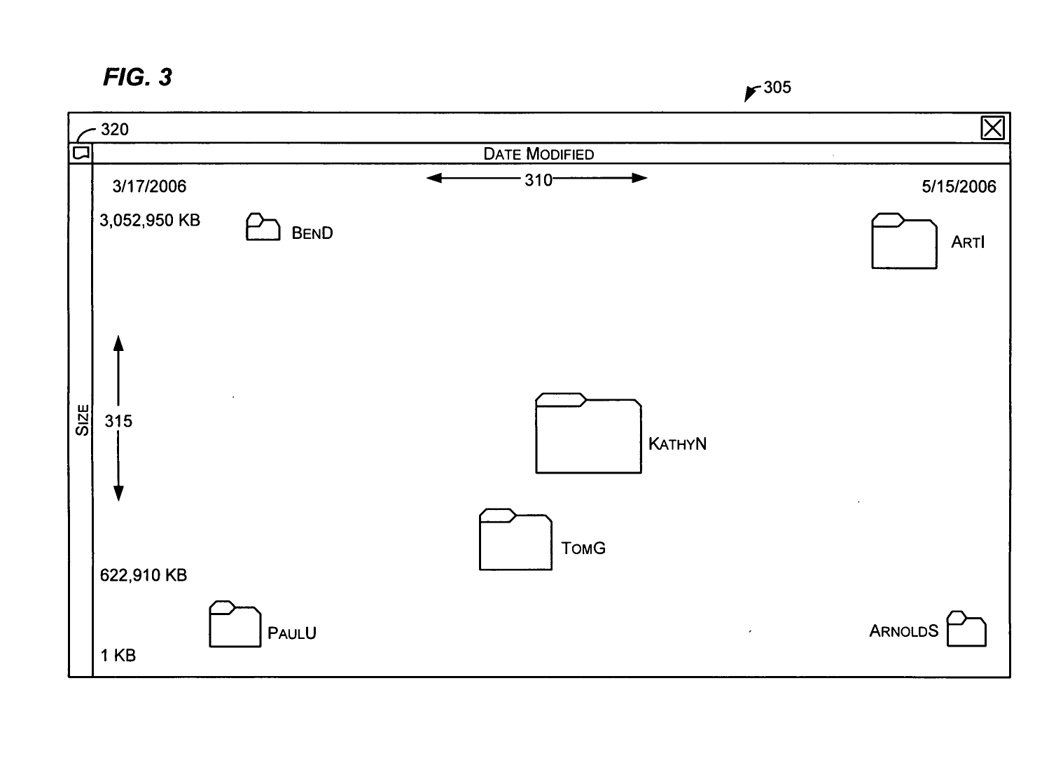

FIG. 3 is a diagram that represents an exemplary window that displays resources in three visualization dimensions in accordance with aspects of the subject matter described herein. In FIG. 3, the date and size attributes are shown in the same visualization dimensions (e.g., horizontal 310 and vertical 315) as that shown in FIG. 2. The size of the icons is another visualization dimension and represents how frequently the resources are accessed. The larger the size of an icon the more frequent the access.

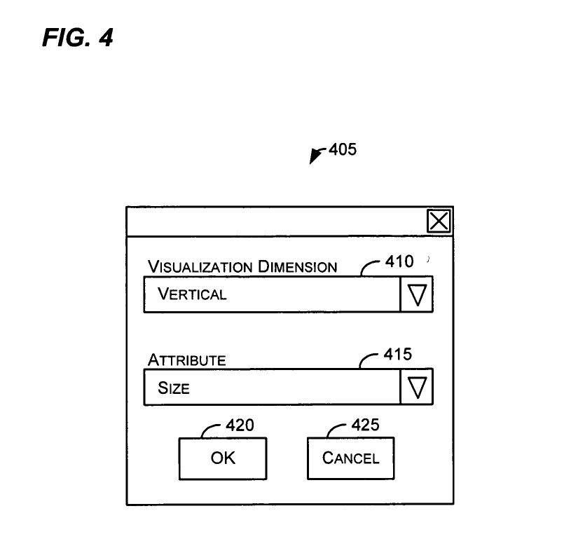

A visualization icon may be located in the area 320 (or elsewhere). The icon may be used to activate a dialog box such as the one described in conjunction with FIG. 4. As described in more detail in conjunction with FIG. 4, this dialog box may allow a user to associate attributes with visualization dimensions.

In addition to, or in lieu of, using vertical, horizontal, and size dimensions to display attributes, other visualization dimensions may be used as well. For example, the icon color, and shape as well as other visual features may be used as visualization dimensions. Another example of a visualization dimension is an apparent distance of an icon to a user in a simulated 3D space. Furthermore, font color, size, italics, bold, underlined, superscripted, subscripted, and other font attributes may be used for visualization dimensions. It will be recognized that other types of visualization dimensions may be used without departing from the spirit or scope of aspects of the subject matter described herein.

FIG. 4 is a diagram that represents an exemplary dialog box that may be used to associate a visualization dimension with an attribute according to aspects of the subject matter described herein. The dialog box 405 includes two drop down list boxes 410 and 415. The drop down list box 410 allows a user to specify a visualization dimension while the drop down list box 415 allows a user to specify an attribute to associate with the visualization dimension. In one embodiment, the dialog box 405 is displayed whenever a user right clicks within a display pane of a resource exploration window (e.g., such as the window 305 of FIG. 3). In another embodiment, a visualization icon may be located somewhere within the window (e.g., at area 320 of FIG. 3). When the user selects the visualization icon, the dialog box 405 is displayed.

When the dialog box is displayed, the user may associate visualization dimensions with attributes. After the user has completed the association, the user may click on the OK button 420 to display the resources in the visualization dimensions or may click on the cancel button 425 to cancel the associations just made.

In another embodiment, a user may associate an attribute with a dimension by right clicking on a selected attribute name and then choosing from a list of available visualization dimensions.

In another embodiment, a user may associate an attribute with a dimension by dragging and dropping an attribute name to a corresponding location. For example, a modification date attribute may be associated with a horizontal dimension by dragging the name “Date Modified” and dropping it near the bottom of a resource explorer panel. Similarly, a file size attribute may be associated with the vertical dimension by dragging the name “Size” and dropping it near the left border of a resource explorer panel.

The above embodiments are exemplary and not all-inclusive of all mechanism for associating an attribute with a visual dimension. It will be recognized that many other ways of associating an attribute with a visual dimension may be used without departing from the spirit or scope of aspects of the subject matter described herein.

To limit the icons that are displayed, a filter may be used. Through a user interface, the user may identify one or more ranges within one or more attributes of the resources. Resources with attributes outside the ranges may be filtered such that they are not considered (and hence not displayed) when displaying icons representing the resources.

The filter may also allow the user to limit the resources that are displayed for attributes that are binary. For example, the filter may allow a user to select attributes that if true (or false) cause the associated resources to be filtered (or not filtered) such that icons representing the resources are displayed (or not displayed) when arranging the icons along visualization dimensions.

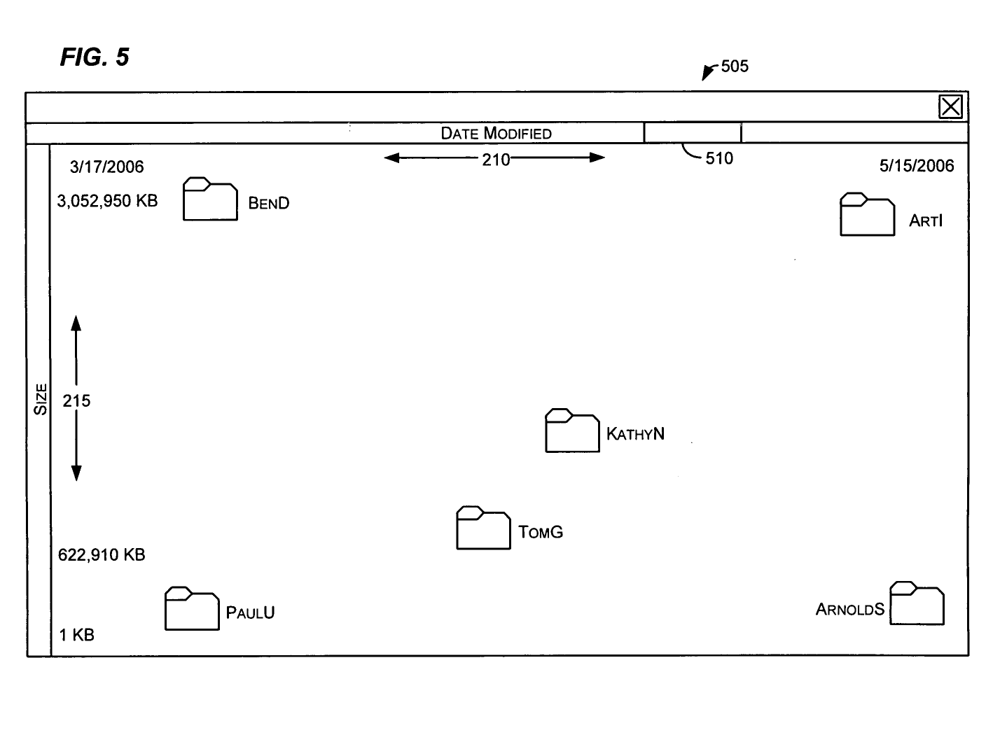

FIG. 5 is a diagram that represents an exemplary window including a view finder that displays resources in two visualization dimensions in accordance with aspects of the subject matter described herein. The window 505 includes a view finder 510. The user may resize the view finder 510 to be larger or smaller by, for example, selecting an edge of the view finder 510 and dragging it. In another embodiment, the view finder 510 may be resized using a scroll wheel of the computer mouse 161. The view finder 510 may be associated with a filter (not shown). The size of the view finder 510 may correspond to a size of a range within the attribute displayed along the horizontal dimension. Sliding the view finder 510 (instead of resizing it) may cause the filter to filter a different range of attributes from the resources.

In an embodiment, a user may be able to type or otherwise select (e.g., from a drop down list) the name of an attribute within the view finder 510 to select a different attribute to associate with the horizontal 210 dimension. There may be a view finder along the vertical 215 or other dimensions that work similarly to the view finder 510 without departing from the spirit or scope of aspects of the subject matter described herein.

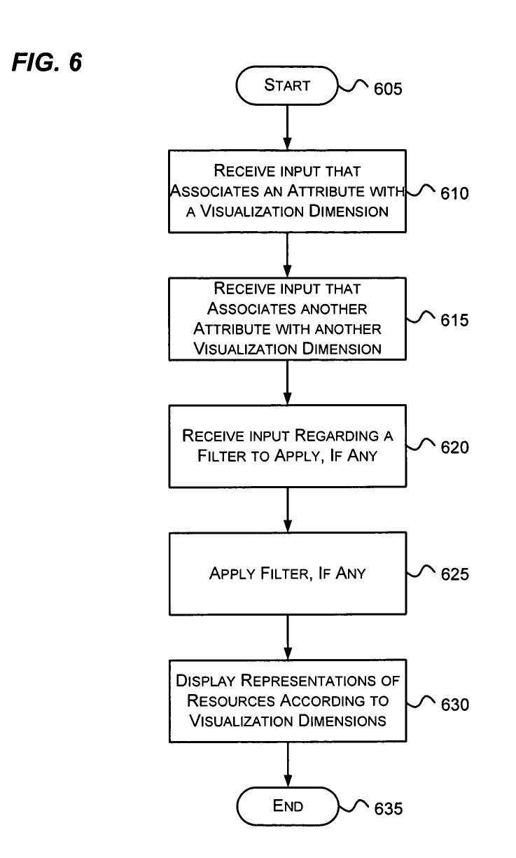

FIG. 6 is a flow diagram that generally represents exemplary actions that may occur in displaying representations of resources according to multiple visualization dimensions according to aspects of the subject matter described herein. At block 605, the actions begin.

At block 610, a user interface receives input that associates an attribute with a visualization dimension. For example, referring to FIG. 4, a dialog box 405 may be used to associate a date modified with a horizontal visualization dimension. In another embodiment, the user interface may receive input such as a default association between a visualization dimension and an attribute.

At block 615, a user interface receives input that associates another attribute with another visualization dimension. For example, referring to FIG. 4, a dialog box 405 may be used to associate a size with a vertical visualization dimension.

In an embodiment, after block 615, other attributes may also be associated with other visualization dimensions if desired. In some embodiments, a user may select multiple attributes at the same time. This may be done, for example, by clicking on attribute names while holding down the shift key, by selecting check boxes of a dialog box, or through other some other user input.

At block 620, a user interface receives input regarding a filter to apply if any. At block 625, the filter is applied to filter resources to those that meet the criteria of the filter.

At block 630, representations of resources are displayed according to the visualization dimensions. In one embodiment, the filter is applied concurrently with displaying the representations. In this embodiment, the actions associated with blocks 625 and 630 may be combined or may execute in parallel.

At block 635, the actions end. One or more of the actions described above may be repeated as a user associates visual dimensions with attributes or applies a filter to or removes a filter from the resources.

As can be seen from the foregoing detailed description, aspects have been described related displaying icons representing resource in multiple dimensions. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A computer-readable medium having computer-executable instructions, which when executed perform actions, comprising:
associating a first attribute of a set of resources with a first visualization dimension;
associating a second attribute of the set of resources with a second visualization dimension; and
displaying icons that represent the resources according to both the first and second visualization dimensions, concurrently.

2. The computer-readable medium of claim 1, further comprising receiving input that identifies the first attribute and the first visualization dimension.

3. The computer-readable medium of claim 1, wherein a visualization dimension comprises a horizontal dimension of a user interface.

4. The computer-readable medium of claim 1, wherein a visualization dimension comprises a vertical dimension of a user interface.

5. The computer-readable medium of claim 1, wherein a visualization dimension comprises a depth dimension of a user interface.

6. The computer-readable medium of claim 1, wherein a visualization dimension comprises one or more of size, color, texture, and shape of the icons.

7. The computer-readable medium of claim 1, wherein a visualization dimension comprises one or more of a font attribute and text associated with the resources.

8. The computer-readable medium of claim 7, wherein the font attribute comprises one or more of size, font, italics, bold, supercripted, subscripted, and underlined.

9. The computer-readable medium of claim 1, wherein displaying icons that represent the resources comprises distributing the icons along a vertical or horizontal dimension of the display according to sizes of the resources.

10. The computer-readable medium of claim 1, wherein an attribute comprises one or more of type, size, creation date, modification date, last access date, name location read/write attributes, security attributes, author, owner, user rating, frequency of access, policies, a number, string, date, and time.

11. The computer-readable medium of claim 1, further comprising visually separating icons that are in a tight cluster or that are overlapping.

12. The method of claim 1, wherein each of the resources is a file or folder of a file system.

13. The method of claim 1, wherein each of the resources is a program or process of a computer system.

14. A method implemented at least in part by a computer, the method comprising:
receiving input that associates a first visualization dimension with a first attribute of a first set of resources;
receiving input that associates a second visualization dimension with a second attribute of the first set of resources;
receiving input that indicates a filter to apply to the first set of resources;
applying the filter to the first set of resources to prepare to display a representation of each of a second set of resources that is a subset of the first set of resources; and
displaying the representation of each of the second set of resources according to the first and second visualization dimensions.

15. The method of claim 14, wherein the filter comprises a view finder that specifies a range of the first attribute.

16. The method of claim 14, wherein the view finder is resizeable to change the range.

17. The method of claim 14, wherein the view finder is slidable to change the range.

18. A user interface for displaying representations of resources, the user interface comprising:
a first visualization dimension associated with a first attribute of the resources;
a second visualization dimension associated with a second attribute of the resources; and
an input mechanism structured to receive an association of an attribute to a visualization dimension.

19. The user interface of claim 18, wherein at least one of the visualization dimensions is spatial.

20. The user interface of claim 18, wherein at least one of the visualization dimensions relates to color.
